(19) United States
(12) Patent Application Publication
(10) Pub. No.: US 2023/0364553 A1
(43) Pub. Date: Nov. 16, 2023

(54) COOLING APPARATUS AND METHOD FOR AMMONIA-BASED DECARBONIZATION

(71) Applicant: Jiangnan Environmental Protection Group Inc., Grand Cayman (KY)

(72) Inventors: Jing Luo, Nanjing (CN); Jun Zhang, Nanjing (CN); Jinyong Wang, Nanjing (CN); Lifang Qi, Beijing (CN)

(21) Appl. No.: 18/195,066

(22) Filed: May 9, 2023

(30) Foreign Application Priority Data
May 16, 2022 (CN) 202210531132.1

(51) Int. Cl. B01D 53/34; B01D 53/75; B01D 53/78; B01D 53/50; B01D 53/62; B01D 53/14

(52) U.S. Cl. CPC B01D 53/343; B01D 53/75; B01D 53/78; B01D 53/507; B01D 53/62; B01D 53/1493; B01D 53/1475; B01D 53/1481; B01D 53/1406; B01D 2257/302; B01D 2257/504; B01D 2251/2062; B01D 2259/652

(57) ABSTRACT

Ammonia-based decarbonization cooling apparatus and a method therefor. The cooling apparatus may include: a first-stage cooling function zone which may use a first circulating liquid to cool a process gas to a temperature of T_{gas 1}, a second-stage cooling function zone which may use a second circulating liquid to cool the process gas to a temperature of T_{gas 2}, and a third-stage cooling function zone which may use a third circulating liquid to cool the process gas to a temperature of T_{gas 3}, wherein T_{gas 3}<T_{gas 2}<T_{gas 1}<T_{gas 0}, and T_{gas 0} is an initial temperature of the process gas when entering the first-stage cooling function zone; a first cold source for cooling the first circulating liquid, a second cold source for cooling the second circulating liquid, and a third cold source for cooling the third circulating liquid, wherein the three cold sources may be different.

### CROSS-REFERENCE TO RELATED APPLICATION

This application claims priority under 35 U.S.C. § 119 of Chinese Patent Application No. CN202210531132.1, filed on May 16, 2022, which is hereby incorporated in its entirety herein.

### TECHNICAL FIELD

The present invention belongs to the technical field of environmental protection, and specifically relates to a pre-cooling apparatus for staged cooling of a process gas prior to ammonia-based decarbonization and a method therefor.

### BACKGROUND

In recent years, the greenhouse effect has gradually become one of the most serious problems faced by humankind. Carbon dioxide (CO₂) is the most important greenhouse gas, and the use of fossil energy is the main source of emission. China's total CO₂ emissions have ranked first in the world, and the situation where China's energy structure is dominated by coal will continue for a period of time, and therefore energy from coal will still be the foundation of new energy peak regulation and energy security. China has promised the world that peak carbon emissions will be reached by 2030 and carbon neutrality by 2060. The capture, storage and resource recovery of CO₂ in the emission gases is of great significance for controlling and reducing greenhouse gas emissions and dealing with the greenhouse effect and global warming.

At present, the amine-based method is the most widely used carbon capture technology in the world. However, the operating cost may be high and it may have a large amount of waste discharge that is difficult to treat. New decarbonization technologies have also been actively explored both at home and abroad. Compared with the amine-based method, the ammonia-based method has the advantages that the regeneration is easy, the operating cost is low, and the by-product of decarbonization is the ammonium bicarbonate fertilizer. Ammonium bicarbonate is a typical compound fertilizer, which can supply nitrogen nutrient and CO₂ to plants at the same time. It is especially suitable for modern agriculture with soilless culture and greenhouse plant growth, realizing the resource utilization of CO₂, achieving carbon cycle, and avoiding secondary pollutions and CO₂ environmental accidents that may be caused by underground carbon storage. Compared with amine, ammonia is more efficient in absorbing CO₂, and the resulting product ammonium bicarbonate can be generated more easily, which greatly reduces the cost of decarbonization.

Ammonia-based decarbonization technology has been the focus of research, and is a way to manage greenhouse gases. However, ammonia is volatile, resulting in increased ammonia escape. If left unsolved, a large amount of ammonia escape will not only increase the cost of decarbonization but also cause secondary pollution. Aiming at this problem, lowering the temperature of decarbonization can reduce ammonia escape.

Patent CN201210410873.0 discloses a multi-stage cooling tower system, comprising a plurality of cooling towers, wherein the outlet water of the preceding cooling tower is used as the inlet water of the subsequent cooling tower to perform multi-stage cooling. This apparatus only performs multi-tower cooling on the same cooling gradient to improve the cooling efficiency, and uses the same cold source.

Patent CN200880122376.2 discloses a multi-stage CO₂ removal system and method for treating flue gas flow, wherein an absorber vessel is used to make the flue gas flow in contact with an ionic solution containing ammonia at a low temperature of 0-20° C., while the solution of the first absorption stage has a higher temperature and a lower ammonia-carbon ratio than the solution of the third absorption stage. By controlling the ionic solution at a low temperature and controlling the ionic solution of the third stage at a still lower temperature, ammonia escape can be reduced; however, this patent does not mention how to reduce the temperature in an efficient and energy-saving way.

It would be desirable to provide a multi-stage cooling apparatus for wet ammonia-based decarbonization and a method therefor. The apparatus may cool a desulfurized gas in a cooling tower by stages through different cold sources, and may reduce capital costs and energy consumption.

### BRIEF DESCRIPTION OF THE DRAWINGS

FIG. 1 shows a pre-cooling apparatus prior to ammonia-based decarbonization according to Example 1.

FIG. 2 shows a pre-cooling apparatus prior to ammonia-based decarbonization according to Example 2.

FIG. 3 shows a pre-cooling apparatus prior to ammonia-based decarbonization according to a Comparative Example.

In the drawings, the various reference marks have the following meanings:

Process gas 1; Decarbonization cooling tower 2; First-stage cooling zone (of cooling tower) 2-1; Second-stage cooling zone (of cooling tower) 2-2; Third-stage cooling zone (of cooling tower) 2-3; Circulation pump (of first-stage cooling zone of cooling tower) 3-1; Circulation pump (of second-stage cooling zone of cooling tower) 3-2; Circulation pump (of third-stage cooling zone of cooling tower) 3-3; Heat exchanger (of first-stage cooling zone of cooling tower) 4-1; Heat exchanger (of second-stage cooling zone of cooling tower) 4-2; Heat exchanger (of third-stage cooling zone of cooling tower) 4-3; Air cooler 4-4; Circulating cooling water 5-1; Chilled water 5-2; Process gas outlet pipeline (of cooling tower) 6; Decarbonization absorption tower 7; Circulation pump (of decarbonization absorption tower) 8; Process gas outlet pipeline (of decarbonization absorption tower) 9; Circulation pump (of water washing zone of ammonia escape control system) 10; Process gas discharge 11; and Ammonia escape control system 12.

### DETAILED DESCRIPTION

Apparatus and methods for pre-cooling process gas are provided.

The apparatus may include a first-stage cooling function zone. The first-stage cooling function zone may use a first circulating liquid to cool a process gas to a temperature of T_{gas 1}. The apparatus may include a second-stage cooling function zone. The second-stage cooling function zone may use a second circulating liquid to cool the process gas to a temperature of T_{gas 2}. The apparatus may include a third-stage cooling function zone. The third-stage cooling function zone may use a third circulating liquid to cool the process gas to a temperature of T_{gas 3}. The apparatus may include a first cold source for cooling the first circulating liquid. The apparatus may include a second cold source for cooling the second circulating liquid. The apparatus may include a third cold source for cooling the third circulating liquid. T_{gas 3} may be less that T_{gas 2}, which may be less than T_{gas 1}, which may be less than T_{gas 0}. T_{gas 0} may be an initial temperature of the process gas when entering the first-stage cooling function zone. The three cold sources may be distinct.

The first cold source may include cooling water. The cooling water may be obtained from a circulating cooling water or a closed cooling tower. The first circulating liquid may be cooled by a first heat exchanger.

The first cold source may include air. The first circulating liquid may be directly cooled by an air cooler.

The second cold source may include a decarbonized cold process gas. The second circulating liquid may be cooled by indirect heat exchange through a second heat exchanger.

The second cold source may include a decarbonized cold process gas. The second circulating liquid may be cooled by direct heat exchange through cross spraying of spraying liquid.

The third cold source may include a chilled liquid. The chilled liquid may be obtained from a chiller. The third circulating liquid may be cooled by a third heat exchanger. The third circulating liquid may be directly cooled by the cold source of the chiller.

Devices that only allow gas to pass through may be provided between the cooling function zones. At least one layer of liquid distributor may be provided in each cooling function zone. The liquid distributor may include a trough distributor or a spray distributor. The three function zones may be disposed in one tower. The three function zones are distributed through multiple towers.

T_{gas 0} may be in the range 40-80° C. T_{gas 1} may be in the range 35-48° C. T_{gas 2} may be in the range 15-40° C. T_{gas 3} may be in the range 10-30° C.

The temperature at which the first circulating liquid enters a tower may be defined as T_{liquid 1}. The temperature at which the first circulating liquid exits the tower may be defined as T_{liquid 1′}. T_{liquid 1} may be less than T_{liquid 1′}. T_{gas 0}−T_{liquid 1′} may be defined as ΔT₁.

The temperature at which the second circulating liquid enters the tower may be defined as T_{liquid2}. The temperature at which the second circulating liquid exits the tower may be defined as T_{liquid2′}. T_{liquid 2} may be less than T_{liquid 2′}. T_{gas 1}−T_{liquid 2′} may be defined as ΔT₂.

The temperature at which the third circulating liquid enters the tower may be defined as T_{liquid3}. The temperature at which the third circulating liquid exits the tower may be defined as T_{liquid 3′}. T_{liquid 3} may be less than T_{liquid 3′}. T_{gas 2}−T_{liquid 3′} may be defined as ΔT₃. Each of ΔT₁, ΔT₂ and ΔT₃ may be, independently of the others, in the range 2-5° C.

T_{liquid 1} may be in the range 10-40° C. T_{liquid 1′} may be in the range 15-50° C. T_{liquid 2} may be in the range 15-36° C. T_{liquid 2′} may be in the range 20-45° C. T_{liquid 3} may be in the range 0-25° C. T_{liquid 3′} may be in the range 10-40° C.

The temperature of the first cold source, before heat exchange, may be defined as T_{source 1} and, after heat exchange, as T_{source 1′}. T_{source 1} may be less than T_{source 1′}.

The temperature of the second cold source, before heat exchange, may be defined as T_{source 2} and, after heat exchange, as T_{source 2′}. T_{source 2} may be less than T_{source 2′}.

The temperature of the third cold source, before heat exchange, may be defined as T_{source 3} and, after heat exchange, as T_{source 3′}. T_{source 3} may be less than T_{source 3′}.

T_{source 1} may be in the range 5-35° C. T_{source 1′} may be in the range 10-45° C. T_{source 2} may be in the range 10-30° C. T_{source 2′} may be in the range 15-40° C. T_{source 3} may be in the range −17 to 10° C. T_{source 3′} may be in the range 0-30° C.

The cooling apparatus may be part of an ammonia-based desulfurization and decarbonization system. An upstream end of the cooling apparatus may be connected to a desulfurization apparatus. A downstream end of the cooling apparatus may be connected to a decarbonization apparatus. The process gas may come from the desulfurization apparatus and may enter the decarbonization apparatus after being cooled by the cooling apparatus.

The method may include passing the process gas successively through: a first-stage cooling function zone which uses a first circulating liquid to cool a process gas to a temperature of T_{gas 1}; a second-stage cooling function zone which uses a second circulating liquid to cool the process gas to a temperature of T_{gas 2}; and a third-stage cooling function zone which uses a third circulating liquid to cool the process gas to a temperature of T_{gas 3}.

The method may include using a first cold source to cool the first circulating liquid. The method may include using a second cold source to cool the second circulating liquid. The method may include using a third cold source to cool the third circulating liquid.

T_{gas 3} may be less than T_{gas 2}, which may be less than T_{gas 1}, which may be less than T_{gas 0}. T_{gas 0} may be defined as an initial temperature of the process gas when entering the first-stage cooling function zone. The three cold sources may be distinct. The three cold sources may be different.

The first cold source may include cooling water from a circulating cooling water or a closed cooling tower. The first circulating liquid may be cooled by a first heat exchanger.

The first cold source may include air. The first circulating liquid may be directly cooled by an air cooler.

The second cold source may include a decarbonized cold process gas. The second circulating liquid may be cooled by indirect heat exchange through a second heat exchanger.

The second cold source may include a decarbonized cold process gas. The second circulating liquid may be cooled by direct heat exchange through cross spraying of spraying liquid.

The third cold source may include a chilled liquid obtained from a chiller. The third circulating liquid may be cooled by a third heat exchanger.

T_{gas 0} may be in the range 40-80° C. T_{gas 1} may be in the range 35-48° C. T_{gas 2} may be in the range 15-40° C. T_{gas 3} may be in the range 10-30° C.

The temperature at which the first circulating liquid enters a tower may be defined as T_{liquid1}. The temperature at which the first circulating liquid exits the tower may be defined as T_{liquid 1′}. T_{liquid 1} may be less than T_{liquid 1′}. T_{gas 0}−T_{liquid 1′} may be defined as ΔT₁.

The temperature at which the second circulating liquid enters the tower may be defined as T_{liquid 2}. The temperature at which the second circulating liquid exits the tower may be defined as T_{liquid2′}. T_{liquid 2} may be less than T_{liquid 2′}. T_{gas 1}−T_{liquid 2′} may be defined as ΔT₂. The temperature at which the third circulating liquid enters the tower may be defined as T_{liquid3}. The temperature at which the third circulating liquid exits the tower may be defined as T_{liquid 3′}. T_{liquid 3} may be less than T_{liquid 3′}. T_{gas 2}−T_{liquid 3′} may be defined as ΔT₃. Each of ΔT₁, ΔT₂ and ΔT₃ may be, independently of the others, in the range 2-5° C.

T_{liquid 1} may be in the range 10-40° C. T_{liquid 1′} may be in the range 15-50° C. T_{liquid 2} may be in the range 15-36° C. T_{liquid 2′} may be in the range 20-45° C. T_{liquid 3} may be in the range 0-25° C. T_{liquid 3′} may be in the range 10-40° C.

the temperature of the first cold source is T_{source 1} before heat exchange and T_{source 1′} after heat exchange, wherein T_{source 1}<T_{source 1′};

the temperature of the second cold source is T_{source 2} before heat exchange and T_{source 2′} after heat exchange, wherein T_{source 2}<T_{source 2′}; and

the temperature of the third cold source is T_{source 3} before heat exchange and T_{source 3′} after heat exchange, wherein T_{source 3}<T_{source 3′}.

T_{source 1} may be in the range 5-35° C. T_{source 1′} may be in the range 10-45° C. T_{source 2} may be in the range 10-30° C. T_{source 2′} may be in the range 15-40° C. T_{source 3} may be in the range −17 to 10° C. T_{source 3′} may be in the range 0-30° C.

The method may include performing on the process gas ammonia-based desulfurization. The method may include performing on the process gas ammonia-based decarbonization. The method may include performing the cooling stages after the ammonia-based desulfurization. The method may include performing the cooling stages before the ammonia-based decarbonization.

A content of ammonium sulfate in the cooling circulating liquid is in the range 0-5 wt % (weight-percent). A content of ammonium sulfate in the first stage may be greater than that in the second stage, which may be greater than that in the third stage.

The apparatus and methods may provide a pre-cooling apparatus prior to ammonia-based decarbonization. The apparatus and methods may include: a first-stage cooling function zone which may use a first circulating liquid to cool a process gas to a temperature of T_{gas 1}, a second-stage cooling function zone which may use a second circulating liquid to cool the process gas to a temperature of T_{gas 2}, and a third-stage cooling function zone which may use a third circulating liquid to cool the process gas to a temperature of T_{gas 3}, wherein T_{gas 3}<T_{gas 2}<T_{gas 1}<T_{gas 0}, and wherein T_{gas 0} is an initial temperature of the process gas when entering the first-stage cooling function zone; a first cold source for cooling the first circulating liquid, a second cold source for cooling the second circulating liquid, and a third cold source for cooling the third circulating liquid, wherein the three cold sources are different.

The apparatus may provide for, and the methods may include, passing the process gas successively through: a first-stage cooling function zone which may use a first circulating liquid to cool the process gas to a temperature of T_{gas 1}, a second-stage cooling function zone which may use a second circulating liquid to cool the process gas to a temperature of T_{gas 2}, and a third-stage cooling function zone which may use a third circulating liquid to cool the process gas to a temperature of T_{gas 3}, wherein T_{gas 3}<T_{gas 2}<T_{gas 1}<T_{gas 0}, and wherein T_{gas 0} is an initial temperature of the process gas when entering the first-stage cooling function zone; using a first cold source to cool the first circulating liquid, using a second cold source to cool the second circulating liquid, and using a third cold source to cool the third circulating liquid, wherein the three cold sources may be different.

The first cold source may include cooling water from a circulating cooling water or a closed cooling tower, and the first circulating liquid may be cooled by a first heat exchanger. The first cold source may include air. The first circulating liquid may be directly cooled by an air cooler. The second cold source may include a decarbonized cold process gas. The second circulating liquid may be cooled by indirect heat exchange through a second heat exchanger. The second circulating liquid may be cooled by direct heat exchange through cross spraying of spraying liquid. The third cold source may include a chilled liquid. The chilled liquid may be obtained from a chiller. The third circulating liquid may be cooled by a third heat exchanger. The third circulating liquid may be directly cooled by the cold source of the chiller.

The circulating cooling water or the cooling water from the closed cooling tower, air from the air cooler, the cold process gas and the chilled liquid may be used respectively as the cold sources, and the process gas may be cooled by spraying the circulating liquids, so cooling capacity with low energy consumption may be achieved. The cooling capacity of the process gas may be recycled. This may save investment costs and reduce energy consumption. The temperature of the process gas may be reduced to a low level, e.g. 10-30° C. This may significantly reduce ammonia escape in the subsequent decarbonization process.

The apparatus and methods may include a pre-cooling apparatus prior to ammonia-based decarbonization. The pre-cooling apparatus may include: a first-stage cooling function zone which may use a first circulating liquid to cool a process gas to a temperature of T_{gas 1}, a second-stage cooling function zone which may use a second circulating liquid to cool the process gas to a temperature of T_{gas 2}, and a third-stage cooling function zone which may use a third circulating liquid to cool the process gas to a temperature of T_{gas 3}, wherein T_{gas 3}<T_{gas 2}<T_{gas 1}<T_{gas 0}, and wherein T_{gas 0} is an initial temperature of the process gas when entering the first-stage cooling function zone; a first cold source for cooling the first circulating liquid, a second cold source for cooling the second circulating liquid, and a third cold source for cooling the third circulating liquid, wherein the three cold sources are different.

The first cold source may include cooling water from a circulating cooling water or a closed cooling tower. The first circulating liquid may be cooled by a first heat exchanger.

The first cold source may include air. The first circulating liquid may be directly cooled by an air cooler.

The second cold source may include a decarbonized cold process gas. The second circulating liquid may be cooled by indirect heat exchange through a second heat exchanger. The second circulating liquid may be cooled by direct heat exchange through cross spraying of spraying liquid.

The third cold source may include a chilled liquid. The chilled liquid may be obtained by a chiller. The third circulating liquid may be cooled by a third heat exchanger. The third circulating liquid may be directly cooled by the cold source of the chiller.

The first heat exchanger and the third heat exchanger may be liquid-liquid heat exchangers. The first heat exchanger and the third heat exchanger may include plate heat exchangers. The second heat exchanger may include a gas-liquid heat exchanger. The second heat exchanger may include a shell-and-tube heat exchanger.

Devices or components that only allow gas to pass through may be provided between the cooling function zones.

One or more layers of circulating distributor may be provided in each cooling function zone.

The circulating distributor may include a trough distributor or a spray distributor.

The three function zones may be combined into one tower or may be present as a plurality of towers.

When the three function zones are combined into one tower, i.e. a cooling tower, the cooling apparatus may include a cooling tower and cold sources. The cooling tower may include, from bottom to top, a first-stage cooling function zone, a second-stage cooling function zone, and a third-stage cooling function zone, wherein each of the cooling function zones and the cold sources may be arranged as described herein.

T_{gas 0} may be in the range 40-80° C.; and/or T_{gas 1} may be in the range 35-48° C.; and/or T_{gas 2} may be in the range 15-40° C.; and/or T_{gas 3} may be in the range 10-30° C.

The temperature at which the first circulating liquid enters the tower is T_{liquid 1}, and the temperature at which the first circulating liquid exits the tower is T_{liquid 1′}, wherein T_{liquid1}<T_{liquid 1′}, and T_{gas 0}−T_{liquid 1′}=ΔT₁. The temperature at which the second circulating liquid enters the tower is T_{liquid 2}. The temperature at which the second circulating liquid exits the tower is T_{liquid 2′}, wherein T_{liquid 2}<T_{liquid 2′}, and T_{gas 1}−T_{liquid 2′}=ΔT₂. The temperature at which the third circulating liquid enters the tower is T_{liquid 3}, and the temperature at which the third circulating liquid exits the tower is T_{liquid 3′}, wherein T_{liquid 3}<T_{liquid 3′}, and T_{gas 2}−T_{liquid 3′}=ΔT₃; wherein ΔT₁, ΔT₂ and ΔT₃ are each independently of the others ≥1° C., in the range 2-15° C., or in the range 2-5° C.

In one embodiment, T_{liquid 1} may be 10-40° C., and T_{liquid 1′} may be 15-50° C.; and/or T_{liquid 2} may be 15-36° C., and T_{liquid 2′} may be 20-45° C.; and/or T_{liquid 3} may be 0-25° C., and T_{liquid 3′} may be 10-40° C.

The temperature of the first cold source is T_{source 1} before heat exchange and T_{source 1′} after heat exchange, wherein T_{source 1} may be less than T_{source 1′}. The temperature of the second cold source is T_{source 2} before heat exchange and T_{source 2′} after heat exchange, wherein T_{source 2} may be less than T_{source 2′}. The temperature of the third cold source is T_{source 3} before heat exchange and T_{source 3′} after heat exchange, wherein T_{source 3} may be less than T_{source 3′}.

T_{source 1} may be in the range 5-35° C., and T_{source 1′} may be in the range 10-45° C.; and/or T_{source 2} may be in the range 10-30° C., and T_{source 2′} may be in the range 15-40° C.; and/or T_{source 3} may be in the range −17 to 10° C., and T_{source 3′} may be in the range 0-30° C.

The cooling apparatus may be part of an ammonia-based desulfurization and decarbonization system. The upstream end of the cooling apparatus may be connected to a desulfurization apparatus. The downstream end of the cooling apparatus may be connected to a decarbonization apparatus. The process gas may come from the desulfurization apparatus and may enter the decarbonization apparatus after being cooled by the cooling apparatus.

The process gas may include a desulfurized process gas from the desulfurization apparatus. The process gas may have a temperature of 40-80° C. The process gas may have a temperature of 40-60° C. The desulfurization process may remove most of SO₂ from the process gas, so that the desulfurized process gas mainly contains CO₂ and a small amount of H₂O.

The methods may include a method for cooling a process gas. The method may include passing the process gas successively through: a first-stage cooling function zone which may use a first circulating liquid to cool the process gas to a temperature of T_{gas 1}, a second-stage cooling function zone which may use a second circulating liquid to cool the process gas to a temperature of T_{gas 2}, and a third-stage cooling function zone which may use a third circulating liquid to cool the process gas to a temperature of T_{gas 3}, wherein T_{gas 3}<T_{gas 2}<T_{gas 1}<T_{gas 0}, and wherein T_{gas 0} is an initial temperature of the process gas when entering the first-stage cooling function zone; using a first cold source to cool the first circulating liquid, using a second cold source to cool the second circulating liquid, and using a third cold source to cool the third circulating liquid, wherein the three cold sources are different.

The first cold source may include cooling water. The cooling water may be from a circulating cooling water or a closed cooling tower. The first circulating liquid may be cooled by a first heat exchanger.

The first cold source may include air. The first circulating liquid may be directly cooled by an air cooler.

The second cold source may include a decarbonized cold process gas. The second circulating liquid may be cooled by indirect heat exchange through a second heat exchanger. The second circulating liquid may be cooled by direct heat exchange through cross spraying of spraying liquid.

The third cold source may include a chilled liquid. The chilled liquid may be obtained by a chiller. The third circulating liquid may be cooled by a third heat exchanger. The third circulating liquid may be directly cooled by the cold source of the chiller.

T_{gas 0} may be in the range 40-80° C.; and/or T_{gas 1} may be in the range 35-48° C.; and/or T_{gas 2} may be in the range 15-40° C.; and/or T_{gas 3} may be in the range 10-30° C.

The temperature at which the first circulating liquid enters the tower is T_{liquid 1}, and the temperature at which the first circulating liquid exits the tower is T_{liquid 1′}, wherein T_{liquid 1′}, and T_{gas 0}−T_{liquid 1′}=ΔT₁; the temperature at which the second circulating liquid enters the tower is T_{liquid 2}, and the temperature at which the second circulating liquid exits the tower is T_{liquid 2′}, wherein T_{liquid 2}<T_{liquid 2′}, and T_{gas 1}−T_{liquid 2′}=ΔT₂; and the temperature at which the third circulating liquid enters the tower is T_{liquid 3}, and the temperature at which the third circulating liquid exits the tower is T_{liquid 3′}, wherein T_{liquid 3}<T_{liquid 3′}, and T_{gas 2}−T_{liquid 3}=ΔT₃; wherein ΔT₁, ΔT₂ and ΔT₃ are each independently of the others ≥1° C., preferably 2-15° C., and more preferably 2-5° C.

T_{liquid 1} may be in the range 10-40° C., and T_{liquid 1′} may be in the range 15-50° C.; and/or T_{liquid 2} may be in the range 15-36° C., and T_{liquid 2′} may be in the range 20-45° C.; and/or T_{liquid 3} may be in the range 0-25° C., and T_{liquid 3′} may be in the range 10-40° C.

The temperature of the first cold source is T_{source 1} before heat exchange and T_{source 1′} after heat exchange, wherein T_{source 1}<T_{source 1′}; the temperature of the second cold source is T_{source 2} before heat exchange and T_{source 2′} after heat exchange, wherein T_{source 2}<T_{source 2′}; and the temperature of the third cold source is T_{source 3} before heat exchange and T_{source 3′} after heat exchange, wherein T_{source 3}<T_{source 3′}.

T_{source 1} may be in the range 5-35° C., and T_{source 1′} may be in the range 10-45° C.; and/or T_{source 2} may be in the range 10-30° C., and T_{source 2′} may be in the range 15-40° C.; and/or T_{source 3} may be in the range −17 to 10° C., and T_{source 3′} may be in the range 0-30° C.

The method may be part of an ammonia-based desulfurization and decarbonization method. Upstream of the cooling method may be the desulfurization process. Downstream of the cooling method may be the decarbonization process. The process gas may come from the desulfurization process and may enter the decarbonization process after being cooled by the cooling method.

The circulating liquid may include water. During the circulation, components entrained by the process gas may enter the circulating liquid, so that the circulating liquid may include such components as ammonium sulfate.

The content of ammonium sulfate in the cooling circulating liquid may be in the range 0-5 wt %, and that in the first stage may be greater than that in the second stage, which may be greater that in the third stage.

The method may be carried out by the cooling apparatus as described herein. The cooling apparatus described herein may be used to perform the method for cooling a process gas described herein. The various features described herein for the cooling apparatus are also applicable to the method, and vice versa.

The following embodiments are provided to illustrate the present invention without limiting its scope.

Illustrative embodiments of apparatus and methods in accordance with the principles of the invention will now be described with reference to the accompanying drawings, which form a part hereof. It is to be understood that other embodiments may be utilized and that structural, functional and procedural modifications, additions or omissions may be made, and features of illustrative embodiments, whether apparatus or method, may be combined, without departing from the scope and spirit of the present invention.

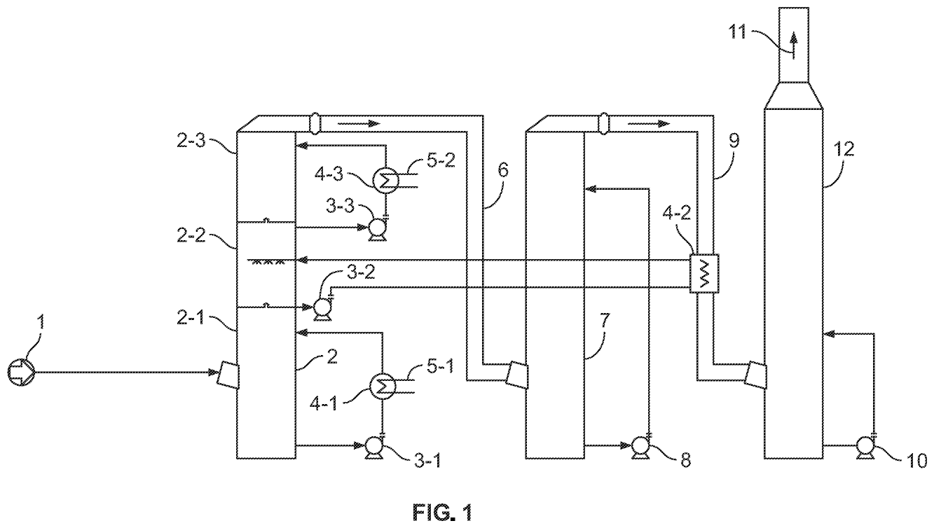

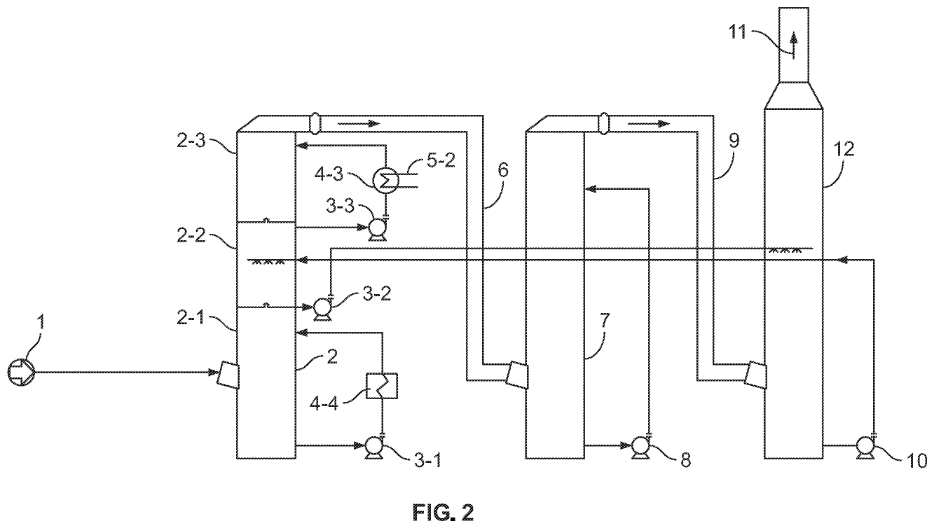

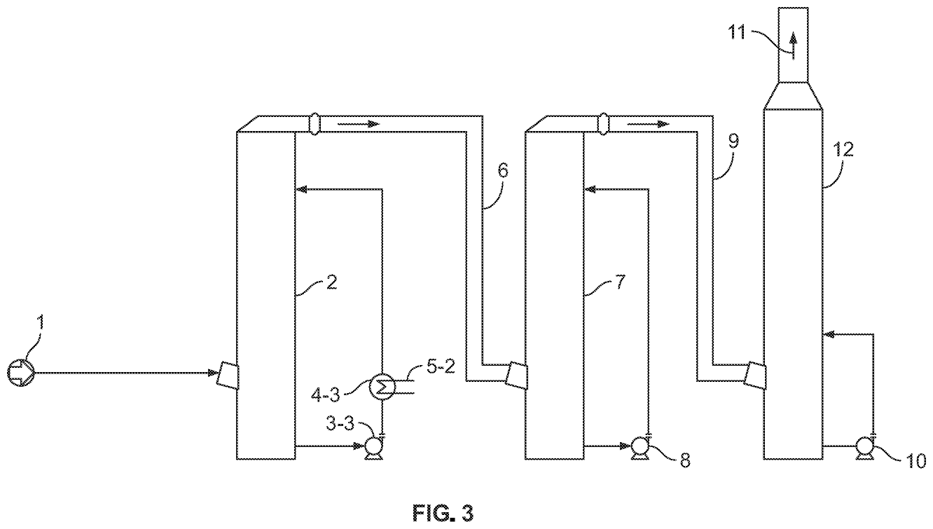

Example 1 is a cooling apparatus according to the present invention and is shown in FIG. 1. Example 2 is a cooling apparatus according to the present invention and is shown in FIG. 2. A Comparative Example is shown in FIG. 3. The difference between FIG. 1 and FIG. 2 lies mainly in the cold source and the cooling mode. In FIG. 1, the first-stage cooling and the second-stage cooling are respectively: the circulating cooling water 5-1 cools the circulating liquid through the heat exchanger 4-1, and the cold process gas 9 cools the circulating liquid through the heat exchanger 4-2. In FIG. 2, the first-stage cooling and the second-stage cooling are respectively: the circulating liquid is cooled by the air cooler 4-4, and the circulating liquid is cooled by spraying contact with the cold process gas 9. In FIG. 3, the cooling tower cools the circulating liquid only by the chilled water 5-2 through the heat exchanger 4-3.

### Example 1

As shown in FIG. 1, the desulfurized process gas 1 (893837 Nm³/h, 50° C.) by ammonia-based method entered the first-stage cooling zone 2-1 of the decarbonization cooling tower 2. The circulating liquid was pumped by the circulation pump 3-1 of the first-stage cooling zone into the cooling tower for spraying and contacting with the process gas to cool the process gas to 42° C. The circulating liquid pipeline was provided with the heat exchanger 4-1, and the circulating liquid was cooled by the circulating cooling water 5-1. The temperature at which the circulating liquid entered the tower was 38° C., and the temperature at which the circulating liquid exited the tower was 48° C. The temperature at which the circulating cooling water entered the heat exchanger was 30° C., and the temperature at which the circulating cooling water exited the heat exchanger was 40° C.

The process gas after the first-stage cooling entered the second-stage cooling zone 2-2 through a liquid collector. The process gas was cooled to 39° C. by means of spraying. The circulating liquid reached the gas heat exchanger 4-2 for heat exchange with decarbonized process gas to reduce the temperature, and then returned to the second-stage cooling zone 2-2 for cooling the process gas. The temperature at which the circulating liquid entered the tower was 30° C., and the temperature at which the circulating liquid exited the tower was 40° C. The temperature of the decarbonized process gas increased from 20° C. to 31° C.

Then, the process gas after the second-stage cooling entered the third-stage cooling zone 2-3 through a liquid collector. The circulating liquid was cooled by chilled water 5-2 through heat exchanger 4-3, and entered the tower for spraying to cool the process gas to 25° C. The temperature at which the circulating liquid entered the tower was 20° C., and the temperature at which the circulating liquid exited the tower was 37° C. The temperature at which the chilled water entered the heat exchanger 4-3 was 7° C., and the temperature at which the chilled water exited the heat exchanger 4-3 was 17° C.

After being cooled by the cooling tower, the process gas was introduced through the flue 6 to the decarbonization tower 7, and the circulating liquid was contacted with the process gas through the circulation pump 8 to absorb carbon dioxide. The decarbonized process gas entered the ammonia escape control system 12 through flue 9, and flue 9 was provided with the gas heat exchanger 4-2. The circulating liquid in the ammonia escape control system was washed by the circulation pump 10 and contacted with the process gas to absorb free ammonia, and the process gas 11 after ammonia removal was vented through a process gas discharge outlet.

The consumption of circulating cooling water was 1890 t/h, and the consumption of chilled water was 1894 t/h.

The main process parameters of the cooling treatment in Example 1 are shown in Table 1.

TABLE 1
Main process parameters of cooling treatment in Example 1

| | | | Temperature | Temperature | Temperature | Temperature |
|---|---|---|---|---|---|---|
| | | | at which | at which | of cold | of cold |
| | Initial | Achieved | circulating | circulating | source | source |
| | process gas | process gas | liquid enters | liquid leaves | before heat | after heat |
| | temperature | temperature | tower | tower | exchange | exchange |
| Example 1 | (° C.) | (° C.) | (° C.) | (° C.) | (° C.) | (° C.) |
| First stage | 50 | 42 | 38 | 48 | 30 | 40 |
| Second stage | 42 | 39 | 30 | 40 | 20 | 31 |
| Third stage | 39 | 25 | 20 | 37 | 7 | 17 |

### Example 2

As shown in FIG. 2, the desulfurized process gas 1 (893837 Nm³/h, 50° C.) by ammonia-based method entered the first-stage cooling zone 2-1 of the decarbonization cooling tower 2. The circulating liquid was pumped by the circulation pump 3-1 of the first-stage cooling zone into the cooling tower for spraying and contacting with the process gas to cool the process gas to 42° C. The circulating liquid pipeline was provided with the air cooler 4-4, and the circulating liquid was directly cooled by the air cooler 4-4. The temperature at which the circulating liquid entered the tower was 38° C., and the temperature at which the circulating liquid exited the tower was 48° C.

The process gas after the first-stage cooling reached the second-stage cooling zone 2-2 through a liquid collector. The process gas was cooled to 32° C. by means of spraying, and the circulating liquid reached ammonia escape control system 12 for heat exchange by spraying with decarbonized process gas to reduce the temperature, and then returned to the second-stage cooling zone 2-2 for cooling the process gas. The temperature at which the circulating liquid entered the cooling tower was 25° C., and the temperature at which the circulating liquid exited the cooling tower was 40° C. The temperature of the decarbonized process gas increased from 20° C. to 35° C.

Then, the process gas after the second-stage cooling entered the third-stage cooling zone 2-3 through a liquid collector, the circulating liquid was cooled by the chilled water 5-2 through the heat exchanger 4-3, and entered the tower for spraying to cool the process gas to 25° C. The temperature at which the circulating liquid entered the tower was 20° C., and the temperature at which the circulating liquid exited the tower was 30° C. The temperature at which the chilled water entered the heat exchanger 4-3 was 7° C., and the temperature at which the chilled water exited the heat exchanger 4-3 was 17° C.

After being cooled by the cooling tower, the process gas was introduced through the flue 6 to the decarbonization tower 7, and the circulating liquid was contacted with the process gas through the circulation pump 8 to absorb carbon dioxide. The decarbonized process gas entered the ammonia escape control system 12 through flue 9. The circulating liquid in the ammonia escape control system was washed by the circulation pump 10, and contacted with the process gas to absorb free ammonia, and the process gas 11 after ammonia removal was vented through a process gas discharge outlet.

The consumption of chilled water was 818 t/h.

The main process parameters of the cooling treatment in Example 2 are shown in Table 2.

TABLE 2
Main process parameters of cooling treatment in Example 2

| | | | Temperature | Temperature | Temperature | Temperature |
|---|---|---|---|---|---|---|
| | | | at which | at which | of cold | of cold |
| | Initial | Achieved | circulating | circulating | source | source |
| | process gas | process gas | liquid enters | liquid leaves | before heat | after heat |
| | temperature | temperature | tower | tower | exchange | exchange |
| Example 2 | (° C.) | (° C.) | (° C.) | (° C.) | (° C.) | (° C.) |
| First stage | 50 | 42 | 38 | 48 | | |
| Second stage | 42 | 32 | 25 | 40 | 20 | 35 |
| Third stage | 32 | 25 | 20 | 30 | 7 | 17 |

### Comparative Example

As shown in FIG. 3, the desulfurized process gas 1 (893837 Nm³/h, 50° C.) by ammonia-based method entered the decarbonization cooling tower 2. The circulating liquid was cooled by chilled water 5-2 through heat exchanger 4-3, and entered the tower for spraying to cool the process gas to 25° C. The temperature at which the circulating liquid entered the tower was 20° C., and the temperature at which the circulating liquid exited the tower was 48° C. The temperature at which the chilled water entered the heat exchanger 4-3 was 7° C., and the temperature at which the chilled water exited the heat exchanger 4-3 was 17° C.

The consumption of chilled water was 4267 t/h.

The main process parameters of the cooling treatment in Comparative Example are shown in Table 3.

TABLE 3
Main process parameters of cooling treatment in Comparative Example

| | | | Temp. at which | Temp. at which | Temp. of | Temp. of |
|---|---|---|---|---|---|---|
| | Initial | Achieved | circulating | circulating | cold source | cold source |
| | process | process | liquid enters | liquid leaves | before heat | after heat |
| Comparative | gas temp. | gas temp. | tower | tower | exchange | exchange |
| Example | (° C.) | (° C.) | (° C.) | (° C.) | (° C.) | (° C.) |
| First stage | 50 | 25 | 20 | 48 | 7 | 17 |

Illustrative features may include:
1. A pre-cooling apparatus prior to ammonia-based decarbonization, comprising:
a first-stage cooling function zone which uses a first circulating liquid to cool a process gas to a temperature of T_{gas 1},
a second-stage cooling function zone which uses a second circulating liquid to cool the process gas to a temperature of T_{gas 2}, and
a third-stage cooling function zone which uses a third circulating liquid to cool the process gas to a temperature of T_{gas 3},
wherein T_{gas 3}<T_{gas 2}<T_{gas 1}<T_{gas 0}, and wherein T_{gas 0} is an initial temperature of the process gas when entering the first-stage cooling function zone;
a first cold source for cooling the first circulating liquid,
a second cold source for cooling the second circulating liquid, and
a third cold source for cooling the third circulating liquid,
wherein the three cold sources are different.
2. The pre-cooling apparatus according to aspect 1, wherein the first cold source is cooling water from a circulating cooling water or a closed cooling tower, and the first circulating liquid is cooled by a first heat exchanger.
3. The pre-cooling apparatus according to aspect 1, wherein the first cold source is air, and the first circulating liquid is directly cooled by an air cooler.
4. The pre-cooling apparatus according to aspect 1, wherein the second cold source is a decarbonized cold process gas, and the second circulating liquid is cooled by indirect heat exchange through a second heat exchanger, or the second circulating liquid is cooled by direct heat exchange through cross spraying of spraying liquid.
5. The pre-cooling apparatus according to aspect 1, wherein the third cold source is a chilled liquid, preferably the chilled liquid is obtained by a chiller, and the third circulating liquid is cooled by a third heat exchanger, or the third circulating liquid is directly cooled by the cold source of the chiller.
6. The pre-cooling apparatus according to any one of aspects 1-5, wherein devices or components that only allow gas to pass through are provided between the cooling function zones.
7. The pre-cooling apparatus according to any one of aspects 1-6, wherein at least one layer of liquid distributor is provided in each cooling function zone, and the liquid distributor may be a trough distributor or a spray distributor.
8. The pre-cooling apparatus according to any one of aspects 1-7, wherein the three function zones may be combined into one tower or may be present as a plurality of towers.
9. The pre-cooling apparatus according to any one of aspects 1-8, wherein
T_{gas 0} is 40-80° C.; and/or
T_{gas 1} is 35-48° C.; and/or
T_{gas 2} is 15-40° C.; and/or
T_{gas 3} is 10-30° C.
10. The pre-cooling apparatus according to any one of aspects 1-9, wherein the temperature at which the first circulating liquid enters the tower is T_{liquid 1}, and the temperature at which the first circulating liquid exits the tower is T_{liquid 1′}, wherein T_{liquid 1}<T_{liquid 1′}, and T_{gas 0}−T_{liquid 1′}=ΔT₁;
the temperature at which the second circulating liquid enters the tower is T_{liquid 2}, and the temperature at which the second circulating liquid exits the tower is T_{liquid 2′}, wherein T_{liquid 2}<T_{liquid 2′}, and T_{gas 1}−T_{liquid 2}=ΔT₂; and
the temperature at which the third circulating liquid enters the tower is T_{liquid 3}, and the temperature at which the third circulating liquid exits the tower is T_{liquid 3′}, wherein T_{liquid 3}<T_{liquid 3′}, and T_{gas 2}−T_{liquid 3′}=ΔT₃;
wherein ΔT₁, ΔT₂ and ΔT₃ are each independently of the others ≥1° C., preferably 2-15° C., and more preferably 2-5° C.
11. The pre-cooling apparatus according to aspect 10, wherein
T_{liquid 1} is 10-40° C., and T_{liquid 1′} is 15-50° C.; and/or
T_{liquid 2} is 15-36° C., and T_{liquid 2′} is 20-45° C.; and/or
T_{liquid 3} is 0-25° C., and T_{liquid 3′} is 10-40° C.
12. The pre-cooling apparatus according to any one of aspects 1-11, wherein the temperature of the first cold source is T_{source 1} before heat exchange and T_{source 1′} after heat exchange, wherein T_{source 1}<T_{source 1′};
the temperature of the second cold source is T_{source 2} before heat exchange and T_{source 2′} after heat exchange, wherein T_{source 2}<T_{source 2′}; and
the temperature of the third cold source is T_{source 3} before heat exchange and T_{source 3′} after heat exchange, wherein T_{source 3}<T_{source 3′}.
13. The pre-cooling apparatus according to aspect 12, wherein
T_{source 1} is 5-35° C., and T_{source 1′} is 10-45° C.; and/or
T_{source 2} is 10-30° C., and T_{source 2′} is 15-40° C.; and/or
T_{source 3} is −17 to 10° C., and T_{source 3′} is 0-30° C.
14. The pre-cooling apparatus according to any one of aspects 1-13, wherein the cooling apparatus is a part of an ammonia-based desulfurization and decarbonization system, the upstream of the cooling apparatus is connected to a desulfurization apparatus, and the downstream of the cooling apparatus is connected to a decarbonization apparatus; the process gas comes from the desulfurization apparatus, and enters the decarbonization apparatus after cooled by the cooling apparatus.
15. A method for cooling a process gas, comprising passing the process gas successively through:
a first-stage cooling function zone which uses a first circulating liquid to cool a process gas to a temperature of T_{gas 1},
a second-stage cooling function zone which uses a second circulating liquid to cool the process gas to a temperature of T_{gas 2}, and
a third-stage cooling function zone which uses a third circulating liquid to cool the process gas to a temperature of T_{gas 3},
wherein T_{gas 3}<T_{gas 2}<T_{gas 1}<T_{gas 0}, and wherein T_{gas 0} is an initial temperature of the process gas when entering the first-stage cooling function zone;
using a first cold source to cool the first circulating liquid,
using a second cold source to cool the second circulating liquid, and
using a third cold source to cool the third circulating liquid,
wherein the three cold sources are different.
16. The method according to aspect 15, wherein the first cold source is cooling water from a circulating cooling water or a closed cooling tower, and the first circulating liquid is cooled by a first heat exchanger.
17. The method according to aspect 15, wherein the first cold source is air, and the first circulating liquid is directly cooled by an air cooler.
18. The method according to aspect 15,
wherein the second cold source is a decarbonized cold process gas, and the second circulating liquid is cooled by indirect heat exchange through a second heat exchanger, or the second circulating liquid is cooled by direct heat exchange through cross spraying of spraying liquid.
19. The method according to aspect 15,
wherein the third cold source is a chilled liquid, preferably the chilled liquid is obtained by a chiller, and the third circulating liquid is cooled by a third heat exchanger, or the third circulating liquid is directly cooled by the cold source of the chiller.
20. The method according to any one of aspects 15-19, wherein
T_{gas 0} is 40-80° C.; and/or
T_{gas 1} is 35-48° C.; and/or
T_{gas 2} is 15-40° C.; and/or
T_{gas 3} is 10-30° C.
21. The method according to any one of aspects 15-20, wherein
the temperature at which the first circulating liquid enters the tower is T_{liquid 1}, and the temperature at which the first circulating liquid exits the tower is T_{liquid 1′}, wherein T_{liquid 1}<T_{liquid 1′}, and T_{gas 0}−T_{liquid 1′}=ΔT₁;
the temperature at which the second circulating liquid enters the tower is T_{liquid 2}, and the temperature at which the second circulating liquid exits the tower is T_{liquid 2′}, wherein T_{liquid 2}<T_{liquid 2′}, and T_{gas 1}−T_{liquid 2′}=ΔT₂; and
the temperature at which the third circulating liquid enters the tower is T_{liquid 3}, and the temperature at which the third circulating liquid exits the tower is T_{liquid 3′}, wherein T_{liquid 3}<T_{liquid 3′}, and T_{gas 2}−T_{liquid 3′}=ΔT₃;
wherein ΔT₁, ΔT₂ and ΔT₃ are each independently of the others ≥1° C., preferably 2-15° C., and more preferably 2-5° C.
22. The method according to aspect 21, wherein
T_{liquid 1} is 10-40° C., and T_{liquid 1′} is 15-50° C.; and/or
T_{liquid 2} is 15-36° C., and T_{liquid 2′} is 20-45° C.; and/or
T_{liquid 3} is 0-25° C., and T_{liquid 3′} is 10-40° C.
23. The method according to any one of aspects 15-22, wherein
the temperature of the first cold source is T_{source 1} before heat exchange and T_{source 1′} after heat exchange, wherein T_{source 1}<T_{source 1′};
the temperature of the second cold source is T_{source 2} before heat exchange and T_{source 2′} after heat exchange, wherein T_{source 2}<T_{source 2′}; and
the temperature of the third cold source is T_{source 3} before heat exchange and T_{source 3′} after heat exchange, wherein T_{source 3}<T_{source 3′}.
24. The method according to aspect 23, wherein
T_{source 1} is 5-35° C., and T_{source 1′} is 10-45° C.; and/or
T_{source 2} is 10-30° C., and T_{source 2′} is 15-40° C.; and/or
T_{source 3} is −17 to 10° C., and T_{source 3′} is 0-30° C.
25. The method according to any one of aspects 15-24, wherein the method is a part of an ammonia-based desulfurization and decarbonization method, the upstream of the cooling method is the desulfurization process, and the downstream of the cooling method is the decarbonization process; the process gas comes from the desulfurization process and enters the decarbonization process after cooled by the cooling method.
26. The method according to any one of aspects 15-24, wherein the content of ammonium sulfate in the cooling circulating liquid is 0-5 wt %, and that in the first-stage> that in the second-stage> that in the third-stage.

While specific embodiments of the present invention have been described above, those skilled in the art should understand that these are only illustrations, and that the scope of the present invention is defined by the appended claims. Various changes and modifications may be made to these embodiments by those skilled in the art without departing from the principle and spirit of the present invention, and these changes and modifications all fall within the scope of the present invention. Moreover, it should be understood by those skilled in the art that the features described herein with respect to one or more embodiments may be combined with other embodiments so long as such combinations do not conflict with objects of the present invention.

All ranges and parameters disclosed herein shall be understood to encompass any and all subranges subsumed therein, every number between the endpoints, and the endpoints. For example, a stated range of “1 to 10” should be considered to include any and all subranges between (and inclusive of) the minimum value of 1 and the maximum value of 10; that is, all subranges beginning with a minimum value of 1 or more (e.g. 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

Thus, apparatus and methods for pre-cooling apparatus prior to ammonia-based decarbonization have been provided. Persons skilled in the art will appreciate that the present invention may be practiced by other than the described embodiments, which are presented for purposes of illustration rather than of limitation. The present invention is limited only by the claims that follow.

What is claimed is:

1. A pre-cooling apparatus prior to ammonia-based decarbonization, comprising:
a first-stage cooling function zone which uses a first circulating liquid to cool a process gas to a temperature of T_{gas 1};
a second-stage cooling function zone which uses a second circulating liquid to cool the process gas to a temperature of T_{gas 2};
a third-stage cooling function zone which uses a third circulating liquid to cool the process gas to a temperature of T_{gas 3};
a first cold source for cooling the first circulating liquid;
a second cold source for cooling the second circulating liquid; and
a third cold source for cooling the third circulating liquid;
wherein:
T_{gas 3}<T_{gas 2}<T_{gas 1}<T_{gas 0};
T_{gas 0} is an initial temperature of the process gas when entering the first-stage cooling function zone; and
the three cold sources are different.

2. The pre-cooling apparatus of claim 1 wherein:
the first cold source is cooling water from a circulating cooling water or a closed cooling tower; and
the first circulating liquid is cooled by a first heat exchanger.

3. The pre-cooling apparatus according to claim 1 wherein:
the first cold source is air; and
the first circulating liquid is directly cooled by an air cooler.

4. The pre-cooling apparatus of claim 1 wherein:
the second cold source is a decarbonized cold process gas; and
the second circulating liquid is cooled by indirect heat exchange through a second heat exchanger.

5. The pre-cooling apparatus of claim 1 wherein:
the second cold source is a decarbonized cold process gas; and
the second circulating liquid is cooled by direct heat exchange through cross spraying of spraying liquid.

6. The pre-cooling apparatus of claim 1 wherein:
the third cold source is a chilled liquid that is obtained by a chiller; and
the third circulating liquid is cooled by a third heat exchanger or the third circulating liquid is directly cooled by the cold source of the chiller.

7. The pre-cooling apparatus of claim 1 wherein devices that only allow gas to pass through are provided between the cooling function zones;
wherein:
at least one layer of liquid distributor is provided in each cooling function zone;
the liquid distributor may be a trough distributor or a spray distributor; and
the three function zones are disposed in one tower.

8. The pre-cooling apparatus of claim 1 wherein devices that only allow gas to pass through are provided between the cooling function zones;
wherein:
at least one layer of liquid distributor is provided in each cooling function zone;
the liquid distributor may be a trough distributor or a spray distributor; and
the three function zones are distributed through multiple towers.

9. The pre-cooling apparatus of claim 1 wherein:
T_{gas 0} is in the range 40-80° C.; and
T_{gas 1} is in the range 35-48° C.; and
T_{gas 2} is in the range 15-40° C.; and
T_{gas 3} is in the range 10-30° C.

10. The pre-cooling apparatus of claim 1 wherein:
the temperature at which the first circulating liquid enters a tower is T_{liquid 1};
the temperature at which the first circulating liquid exits the tower is T_{liquid 1′}, wherein T_{liquid 1}<T_{liquid 1′}, and T_{gas 0}−T_{liquid 1′}=ΔT₁;
the temperature at which the second circulating liquid enters the tower is T_{liquid2};
the temperature at which the second circulating liquid exits the tower is T_{liquid2′}, wherein T_{liquid 2}<T_{liquid 2′}, and T_{gas 1}−T_{liquid 2′}=ΔT₂;
the temperature at which the third circulating liquid enters the tower is T_{liquid3};
the temperature at which the third circulating liquid exits the tower is T_{liquid 3′}, wherein T_{liquid 3}<T_{liquid 3′}, and T_{gas 2}−T_{liquid 3′}=ΔT₃; and
each of ΔT₁, ΔT₂ and ΔT₃ is, independently of the others, in the range 2-5° C.

11. The pre-cooling apparatus of claim 10 wherein:
T_{liquid 1} is in the range 10-40° C., and T_{liquid 1′} is in the range 15-50° C.; and
T_{liquid 2} is in the range 15-36° C., and T_{liquid 2′} is in the range 20-45° C.; and
T_{liquid 3} is in the range 0-25° C., and T_{liquid 3′} is in the range 10-40° C.

12. The pre-cooling apparatus of claim 1 wherein:
the temperature of the first cold source is T_{source 1} before heat exchange and T_{source 1′} after heat exchange, wherein T_{source 1}<T_{source 1′};
the temperature of the second cold source is T_{source 2} before heat exchange and T_{source 2′} after heat exchange, wherein T_{source 2}<T_{source 2′}; and
the temperature of the third cold source is T_{source 3} before heat exchange and T_{source 3′} after heat exchange, wherein T_{source 3}<T_{source 3′}.

13. The pre-cooling apparatus of claim 12 wherein
T_{source 1} is in the range 5-35° C., and T_{source 1′} is in the range 10-45° C.; and
T_{source 2} is in the range 10-30° C., and T_{source 2′} is in the range 15-40° C.; and
T_{source 3} is in the range −17 to 10° C., and T_{source 3′} is in the range 0-30° C.

14. The pre-cooling apparatus of claim 1 wherein:
the cooling apparatus is a part of an ammonia-based desulfurization and decarbonization system;
an upstream end of the cooling apparatus is connected to a desulfurization apparatus;
a downstream end of the cooling apparatus is connected to a decarbonization apparatus; and
the process gas comes from the desulfurization apparatus and enters the decarbonization apparatus after being cooled by the cooling apparatus.

15. A method for cooling a process gas, the method comprising:
passing the process gas successively through:
a first-stage cooling function zone which uses a first circulating liquid to cool a process gas to a temperature of T_{gas 1};
a second-stage cooling function zone which uses a second circulating liquid to cool the process gas to a temperature of T_{gas 2}; and
a third-stage cooling function zone which uses a third circulating liquid to cool the process gas to a temperature of T_{gas 3};
using a first cold source to cool the first circulating liquid;
using a second cold source to cool the second circulating liquid; and
using a third cold source to cool the third circulating liquid;
wherein:
T_{gas 3}<T_{gas 2}<T_{gas 1}<T_{gas 0};
T_{gas 0} is an initial temperature of the process gas when entering the first-stage cooling function zone; and
the three cold sources are distinct.

16. The method of claim 15 wherein:
the first cold source is cooling water from a circulating cooling water or a closed cooling tower; and
the first circulating liquid is cooled by a first heat exchanger.

17. The method of claim 15 wherein:
the first cold source is air; and
the first circulating liquid is directly cooled by an air cooler.

18. The method of claim 15 wherein:
the second cold source is a decarbonized cold process gas, and
the second circulating liquid is cooled by indirect heat exchange through a second heat exchanger.

19. The method of claim 15 wherein:
the second cold source is a decarbonized cold process gas, and
the second circulating liquid is cooled by direct heat exchange through cross spraying of spraying liquid.

20. The method of claim 15 wherein:
the third cold source is a chilled liquid obtained from a chiller; and
the third circulating liquid is cooled by a third heat exchanger.

21. The method of claim 15 wherein:
T_{gas 0} is in the range 40-80° C.;
T_{gas 1} is in the range 35-48° C.;
T_{gas 2} is in the range 15-40° C.; and
T_{gas 3} is in the range 10-30° C.

22. The method of claim 15 wherein:
the temperature at which the first circulating liquid enters a tower is T_{liquid1}, and the temperature at which the first circulating liquid exits the tower is T_{liquid 1′}, wherein T_{liquid 1}<T_{liquid 1′}, and T_{gas 0}−T_{liquid 1′}=ΔT₁;
the temperature at which the second circulating liquid enters the tower is T_{liquid 2}, and the temperature at which the second circulating liquid exits the tower is Nuke′, wherein T_{liquid 2}<T_{liquid 2′}, and T_{gas 1}−T_{liquid 2}=ΔT₂; and
the temperature at which the third circulating liquid enters the tower is T_{liquid3}, and the temperature at which the third circulating liquid exits the tower is T_{liquid 3′}, wherein T_{liquid 3}<T_{liquid 3′}, and T_{gas 2}−T_{liquid 3′}—ΔT₃; and
each of ΔT₁, ΔT₂ and ΔT₃ is, independently of the others, in the range 2-5° C.

23. The method of claim 22 wherein:
T_{liquid 1} is in the range 10-40° C., and T_{liquid 1′} is in the range 15-50° C.;
T_{liquid 2} is in the range 15-36° C., and T_{liquid 2′} is in the range 20-45° C.; and
T_{liquid 3} is in the range 0-25° C., and T_{liquid 3′} is in the range 10-40° C.

24. The method of claim 15 wherein:
the temperature of the first cold source is T_{source 1} before heat exchange and T_{source 1′} after heat exchange, wherein T_{source 1}<T_{source 1′};
the temperature of the second cold source is T_{source 2} before heat exchange and T_{source 2′} after heat exchange, wherein T_{source 2}<T_{source 2′}; and
the temperature of the third cold source is T_{source 3} before heat exchange and T_{source 3′} after heat exchange, wherein T_{source 3}<T_{source 3′}.

25. The method of claim 24 wherein
T_{source 1} is in the range 5-35° C., and T_{source 1′} is in the range 10-45° C.; and
T_{source 2} is in the range 10-30° C., and T_{source 2′} is in the range 15-40° C.; and
T_{source 3} is in the range −17 to 10° C., and T_{source 3′} is in the range 0-30° C.

26. The method of claim 15 further comprising:
performing on the process gas:
ammonia-based desulfurization; and
ammonia-based decarbonization; and
performing the cooling stages:
after the ammonia-based desulfurization; and
before the ammonia-based decarbonization.

27. The method of claim 15 wherein a content of ammonium sulfate:
in the cooling circulating liquid is in the range 0-5 wt %; and
in the first stage is greater than that in the second stage, which is greater than that in the third stage.
